(19) United States
(12) Patent Application Publication
(10) Pub. No.: US 2026/0112755 A1
(43) Pub. Date: Apr. 23, 2026

(54) STRUCTURAL ASSEMBLY FOR A VEHICLE

(71) Applicant: Ford Global Technologies, LLC, Dearborn, MI (US)

(72) Inventors: Himanshu Khandelwal, Warren, MI (US); Robert Reiners, Ypsilanti, MI (US); Michael Kozak, Canton, MI (US); Alan Pieniadz, Northville, MI (US); Diego Eduardo Mendoza Hernandez, Mexico City (MX); Nicholas Braeseker, Novi, MI (US); Vladimir Vladimirovich Bogachuk, West Bloomfield, MI (US)

(73) Assignee: Ford Global Technologies, LLC, Dearborn, MI (US)

(21) Appl. No.: 18/920,116

(22) Filed: Oct. 18, 2024

(51) Int. Cl. H01M 50/249; B60K 1/04; B62D 21/02

(52) U.S. Cl. CPC H01M 50/249; B60K 1/04; B60K 2001/0438; B62D 21/02

(57) ABSTRACT

A structural assembly that includes a vehicle frame, a battery structure and at least one discrete energy absorbing structure. The vehicle frame has opposed longitudinal rails. The battery structure is configured to house battery components and is disposed between the opposed longitudinal rails. The discrete energy absorbing structure extends from an outer side of the battery structure toward a respective longitudinal rail of the opposed longitudinal rails. The discrete energy absorbing structure is spaced apart from the respective longitudinal rail.

### FIELD

The present disclosure relates to a structural assembly and more particularly to a structural assembly for an electric vehicle.

### BACKGROUND

The statements in this section merely provide background information related to the present disclosure and may not constitute prior art.

The desire to reduce automotive fuel consumption and emissions has been well documented. Thus, electric vehicles have been developed to significantly reduce reliance on internal combustion engines. In general, electric vehicles differ from conventional motor vehicles because they are driven by one or more rechargeable battery packs having lithium-ion batteries, for example, or any other suitable electrical power storage units. The battery pack typically powers one or more motors to drive a set of wheels. The size and weight of the battery pack is typically greater for electric vehicles capable of traveling long distances (e.g., electric vehicles capable of traveling more than 500 miles). Depending on the mounting location relative to the electric vehicle, the battery pack may be susceptible to various vehicle loads.

Integration of rechargeable battery packs into the structure of existing vehicles and providing efficient load paths in a variety of operating conditions can be challenging, primarily due to the increased weight of the battery packs and their larger footprint in the vehicle. The present disclosure addresses these and other issues related to the integration of rechargeable battery packs in electric vehicles.

### SUMMARY

This section provides a general summary of the disclosure and is not a comprehensive disclosure of its full scope or all of its features.

In one form, the present disclosure provides a structural assembly for a vehicle that includes a vehicle frame, a battery structure and at least one discrete energy absorbing structure. The vehicle frame has opposed longitudinal rails. The battery structure is configured to house battery components and is disposed between the opposed longitudinal rails. The discrete energy absorbing structure extends from an outer side of the battery structure toward a respective longitudinal rail of the opposed longitudinal rails. The discrete energy absorbing structure is spaced apart from the respective longitudinal rail.

In variations of the structural assembly of the above paragraph, which can be implemented individually or in any combination: the battery structure includes a battery tray and a lid coupled to the battery tray, the discrete energy absorbing structure extends from the outer side of the lid of the battery structure; the battery structure includes a cross member disposed within the battery tray and spanning substantially an entire width of the battery tray, the discrete energy absorbing structure is laterally aligned with the cross member; the battery structure includes a cross member disposed within the battery structure and spanning substantially an entire width of the battery structure, the discrete energy absorbing structure is laterally aligned with the cross member; the discrete energy absorbing structure includes a mounting feature that is configured to support vehicle components extending along the battery structure; the discrete energy absorbing structure includes a plurality of discrete energy absorbing structures extending from the outer side of the battery structure toward the respective longitudinal rail; each of the plurality of discrete energy absorbing structures includes a mounting feature that is configured to support vehicle components extending along the battery structure; the plurality of discrete energy absorbing structures are spaced apart from each other along a longitudinal direction of the vehicle; the discrete energy absorbing structure extends from an upper portion of the battery structure and faces an inboard side of the respective longitudinal rail; the structural assembly further includes a vehicle body separate from and mounted on the vehicle frame, the vehicle body including opposed rockers extending in a longitudinal direction of the vehicle, one longitudinal rail of the opposed longitudinal rail is located between a respective rocker and the discrete energy absorbing structure; the structural assembly further includes a plurality of mounts secured to a respective opposed longitudinal rail and a plurality of jounce bumpers, each jounce bumper disposed on a respective mount and between the respective mount and the vehicle body.

In another form, the present disclosure provides a structural assembly for a vehicle that includes a vehicle frame, a battery structure, a set of discrete left energy absorbing structures, and a set of discrete right energy absorbing structures. The vehicle frame has left and right longitudinal rails. The battery structure is configured to house battery components and is disposed between the left and right longitudinal rails. The set of discrete left energy absorbing structures extend from a left side of the battery structure towards the left longitudinal rail. The set of discrete left energy absorbing structures are spaced apart from the left longitudinal rail. The set of discrete right energy absorbing structures extend from a right side of the battery structure towards the right longitudinal rail. The set of discrete right energy absorbing structures are spaced apart from the right longitudinal rail.

In variations of the structural assembly of the above paragraph, which can be implemented individually or in any combination: each left discrete energy absorbing structure is laterally aligned with a respective right discrete energy absorbing structure; the battery structure includes a cross member disposed within the battery structure and spanning substantially an entire width of the battery structure, one discrete left energy structure of the set of left energy structures and one discrete right energy structure of the set of right energy structures are laterally aligned with the cross member; the battery structure includes a battery tray and a lid coupled to the battery tray, the set of discrete left energy absorbing structures and the set of discrete right energy absorbing structure extend from an outer side of the lid of the battery structure; each of the set of discrete left energy absorbing structures includes a first mounting feature that is configured to support first vehicle components extending along the battery structure; each of the set of discrete right energy absorbing structures includes a second mounting feature that is configured to support second vehicle components extending along the battery structure; the structural assembly further includes a vehicle body separate from and mounted on the vehicle frame, the vehicle body including left and right rockers extending in a longitudinal direction of the vehicle, the left longitudinal rail located between the left rocker and the set of discrete left energy absorbing structures and the right longitudinal rail located between the right rocker and the set of discrete right energy absorbing structures; a plurality of mounts secured to the right and left longitudinal rails; a plurality of jounce bumpers, each jounce bumper disposed on a respective mount and between the respective mount and the vehicle body; the set of discrete left energy absorbing structures extends from an upper portion of the battery structure and faces an inboard side of the left longitudinal rail; and the set of discrete right energy absorbing structures extends from the upper portion of the battery structure and faces an inboard side of the right longitudinal rail.

In yet another form, the present disclosure provides a structural assembly for a vehicle that includes a vehicle frame, a vehicle body, a battery structure, a set of discrete left energy absorbing structures, and a set of discrete right energy absorbing structures. The vehicle frame has left and right longitudinal rails. The vehicle body is separate from and mounted on the vehicle frame. The vehicle body includes left and right rockers extending in a longitudinal direction of the vehicle. The battery structure is configured to house battery components and is disposed between the left and right longitudinal rails. The battery structure includes a battery tray, a lid secured to the battery tray, and a plurality of cross members disposed within the battery structure and spaced apart along a longitudinal direction of the battery tray. The set of discrete left energy absorbing structures extend from a left side of the lid towards the left longitudinal rail. The set of discrete left energy absorbing structures are spaced apart from the left longitudinal rail. The set of discrete right energy absorbing structures extend from a right side of the lid towards the right longitudinal rail. The set of discrete right energy absorbing structures are spaced apart from the right longitudinal rail. A respective discrete left energy structure of the set of left energy structures and a respective discrete right energy structure of the set of right energy structures are laterally aligned with a respective cross member of the plurality of cross members.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a vehicle including a battery structure according to the principles of the present disclosure;

FIG. 2 is a perspective view of a portion of a vehicle frame, a vehicle body, and a battery structure of the vehicle of FIG. 1;

FIG. 3 is a cross-sectional view of the vehicle frame, the vehicle body, and the battery structure of the vehicle of FIG. 1;

FIG. 4. is a close-up view of portion indicated as area 4 in FIG. 3;

FIG. 5 is a perspective view of the battery structure of the vehicle in FIG. 1;

FIG. 6 is a bottom view of the vehicle frame and the battery structure of the vehicle of FIG. 1;

FIG. 7 is a perspective view of one energy absorbing structure of the vehicle of FIG. 1;

FIG. 8 is another perspective view of one energy absorbing structure of the vehicle of FIG. 1; and

FIG. 9 is a cross-sectional view of a portion of the vehicle of FIG. 1 following a structural deformation event.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

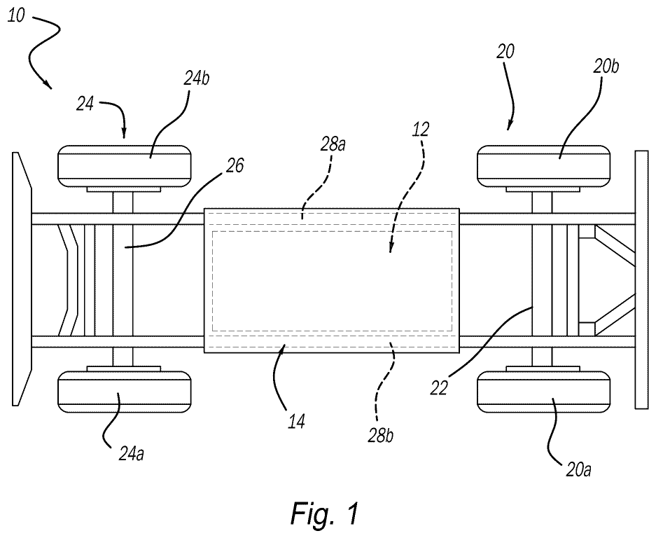

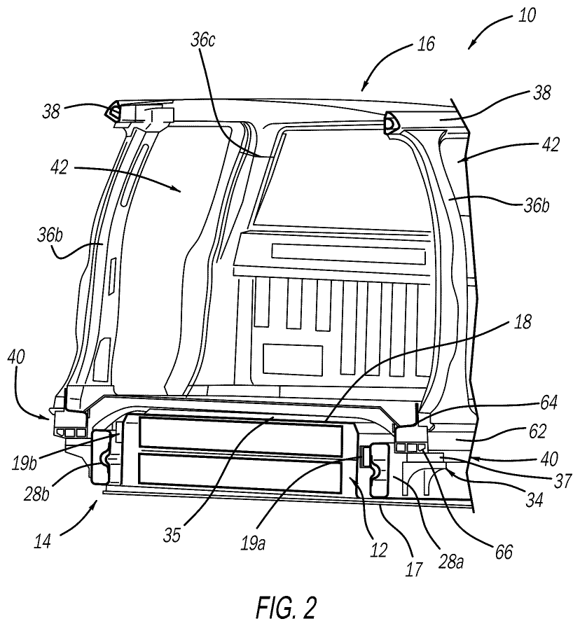

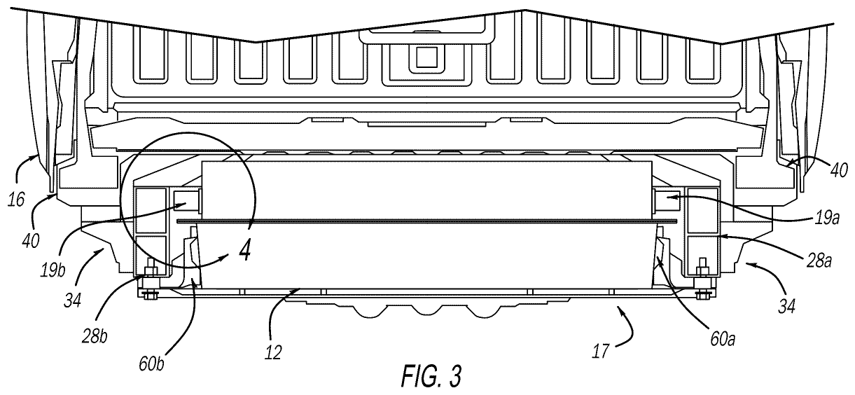

With reference to FIGS. 1-3, a vehicle 10 such as an electric vehicle is provided. In the example provided, the electric vehicle is a battery electric vehicle (BEV). In other examples, the electric vehicle may be a hybrid electric vehicle (HEV), a plug-in electric vehicle (PHEV), or a fuel cell vehicle. The vehicle 10 includes a battery structure or battery housing assembly 12, a vehicle frame 14, a vehicle body 16 (FIGS. 2 and 3), and a set of right and left discrete energy absorbing structures or blocks 19a, 19b (FIGS. 2 and 3). The battery structure 12 may be rechargeable and may include lithium-ion batteries, solid-state batteries, or any other suitable electrical power storage units. The battery structure 12 may be disposed at various locations of the vehicle 10 and may be secured to the vehicle frame 14 via a battery mounting structure 17. In this way, the battery structure 12 is supported by the vehicle frame 14 and is remote from a passenger cabin (not shown) and cargo compartments (not shown) of the vehicle 10, therefore, not occupying space that would otherwise be available for passengers or cargo. One example of the battery mounting structure is disclosed in U.S. Patent App. No. Ser. No. 17/859,754, and titled “MOUNTING STRUCTURE FOR ELECRTIC VEHICLE” which is commonly owned with the present application and the contents of which are incorporated herein by reference in its entirety.

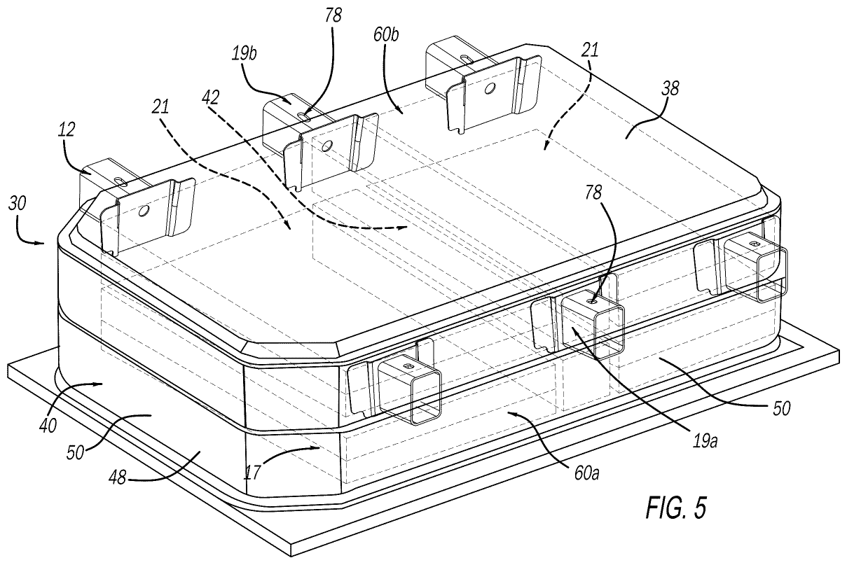

The battery structure 12 powers a rear motor (not shown) to drive rear wheels 20a, 20b of a set of rear wheels 20 via a rear axle 22. Similarly, the battery structure 12 may selectively power a front motor (not shown) to drive front wheels 24a, 24b of a set of front wheels 24 via a front axle 26. With reference to FIG. 5, the battery structure 12 includes one or more battery arrays 21 and a battery tray or housing 30. The battery housing 30 is an enclosure which provides a structural surrounding and sealed compartment for the battery arrays 21 and other battery components such as cooling lines, support brackets, and wiring disposed therein. The battery arrays 21 may be rechargeable and may include lithium-ion batteries or any other suitable electrical power storage units. In the example illustrated, the battery arrays 21 are stacked on top of each other.

The battery housing 30 may be disposed at various locations of the vehicle 10 and is mounted to the vehicle frame 14. In this way, the battery housing 30 is supported by the vehicle frame 14 and is remote from a passenger cabin (not shown) and cargo compartments (not shown) of the vehicle 10. The battery housing 30 includes a lid 38, a body 40, and one or more internal cross members 42 (schematically illustrated in dashed lines for ease of illustration). The lid 38 at least partially overlaps the body 40 and is removably coupled to the body 40 via mechanical fasteners such as bolts or screws (not shown), for example. In this way, the lid 38 may be removed to service the battery arrays 21 disposed within the battery housing 30.

The body 40 includes a bottom wall or panel 48 and one or more side walls or panels 50. The bottom wall 48 supports the battery arrays 21 disposed within the battery housing 30 and is secured to lower portions of the side walls 50. For example, the bottom wall 48 is secured to the lower portions of the side walls 50 via welding, an adhesive, or any other suitable attachment means. The side walls 50 are manufactured via stamping, for example, and extend in a vertical direction. The side walls 50 define an outer boundary of the body 40 and are secured to each other via welding or an adhesive, for example. A seal (not shown) is disposed around a periphery of the side walls 50 of the battery housing 30 and is engaged with side walls 50 and the lid 38. In this way, fluids, debris and other materials are inhibited from entering into the battery housing 30. The internal cross members 42 are disposed within the body 40 and extend in a transverse direction of the vehicle 10 (i.e., perpendicular to a longitudinal direction of the vehicle 10). The internal cross members 42 may connect opposed side walls 50. The internal cross members 42 abut against the bottom wall 48 of the body 40 and are spaced apart along a longitudinal direction of the vehicle 10.

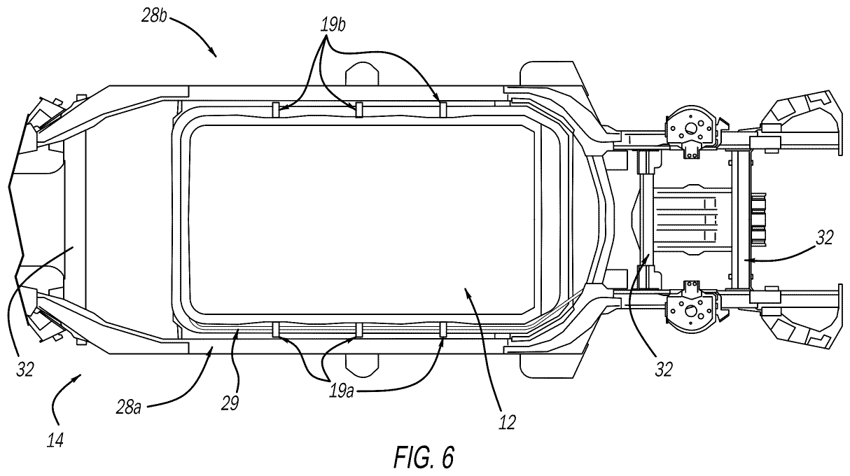

With additional reference to FIG. 6, the vehicle frame 14 is made of a metal material such as steel, for example, and is the main supporting structure of the vehicle 10, to which various components are attached either directly or indirectly. For example, a suspension system (not shown) may be secured to the vehicle frame 14, and secures the wheels 20, 24 of the vehicle 10 to the vehicle frame 14. The suspension system provides a smooth ride by absorbing energy from various road bumps while driving, and assists the wheels 20, 24 to remain in contact with the road. The suspension system includes various components such as upper and lower control arms, shock absorbers, and ball joints, for example.

The vehicle frame 14 includes opposed longitudinal rails 28a, 28b (i.e., right and left rails 28a, 28b) and cross members 32. The rails 28a, 28b are spaced apart from each other and may establish a length of the vehicle frame 14. The rails 28a, 28b are also spaced apart from a respective side of the battery structure 12. In this way, components 29 such as electrical conduits or fluid conduits, for example, may extend along and between the battery structure 12 and the rails 28a, 28b. The cross members 32 connect the rails 28a, 28b to each other. The suspension system (not shown) may be secured to the rails 28a, 28b and/or the cross members 32. It should be understood that the vehicle frame 14 does not include cross members at or near a center portion thereof to accommodate the battery structure 12. It should also be understood that the rails 28a, 28b are spaced apart a greater distance at the center portion of the vehicle frame 14 than at the ends of the vehicle frame 14. One or more mounts 34 are secured to and along a respective rail 28a, 28b of the vehicle frame 14 at or near the center portion of the vehicle frame 14.

With reference to FIGS. 2 and 3, the vehicle body 16 is separate from and mounted on the vehicle frame 14. Stated differently, the vehicle body 16 is mounted on the plurality of mounts 34 secured to the vehicle frame 14. Jounce bumpers 37 are disposed on a respective mount 34 and between the respective mount 34 and the vehicle body 16. The vehicle body 16 includes cross members 35 (only one shown in the figures) extending above the opposed longitudinal rails 28a, 28b and the battery structure 12.

The vehicle body 16 also includes a front end (not shown), a plurality of pillars 36b, 36c, upper rails 38, and rockers 40. In one example, the front end includes a bumper (not shown), a pair of opposed beams or inner rails (not shown), and a pair of opposed rails (not shown). The bumper extends in a transverse direction relative to a longitudinal direction of the vehicle 10 and is secured to front ends of the pair of beams. Each beam extends from one respective pillar (not shown) to the bumper. Each beam is also arcuate and extends around a front wheel 24a, 24b of the vehicle 10 and forms a portion of a respective front wheel well. The rails are positioned above the beams and extend from one pillar (not shown) to a respective beam. The rails also form a portion of a respective front wheel well.

The pillars 36b, 36c, the rockers 40 and the upper rails 38 cooperate to define door openings 42 in the vehicle body 16. Doors (not shown) are rotatably coupled to pillars (not shown) between a closed position (not shown) in which the doors are disposed within the door openings 42 and an open position (not shown) in which the doors are removed from the door openings 42.

Each rocker 40 is elongated and extends along the longitudinal direction of the vehicle 10. Each rocker 40 also overlaps a respective opposed longitudinal rail 28a, 28b. Each opposed longitudinal rail 28a, 28b is located between a respective rocker 40 and the battery structure 12. The rocker 40 includes an outer member 62, the inner member 64, and an inner rocker 66. The outer member 62 is secured to the inner member 64 via welding. In some configurations, the outer member 62 is secured to the inner member 64 with mechanical fasteners. The cross members 35 extend from the inner member 64. The inner rocker 66 is housed within a cavity formed via the outer and inner members 62, 64, and extends along an inboard portion of the outer member 62.

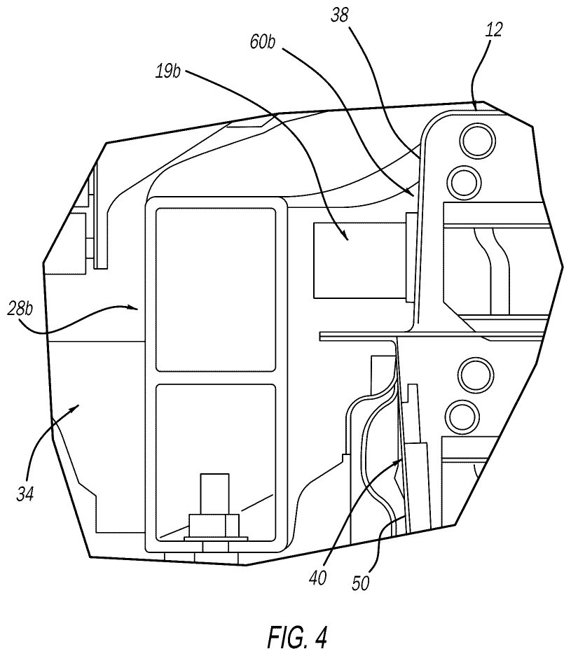

With reference to FIGS. 3-5, the set of discrete right energy absorbing structures 19a are coupled (e.g., welded) to a right side 60a of the battery structure 12 and are spaced apart along a length of the right side 60a of the battery structure 12. In the example illustrated, the set of discrete right energy absorbing structures 19a are located external to the battery housing 30 and are coupled to the lid 38 of the battery housing 30. In some forms, the set of discrete right energy absorbing structures 19a may be coupled to the body 40 of the battery housing 30. In other forms, a first set of discrete right energy absorbing structures may be coupled to the lid 38 of the battery housing 30 and a second set of discrete right energy absorbing structures may be coupled to the body 40 of the battery housing 30. In the example illustrated, the set of discrete right energy absorbing structures 19a are spaced apart from the rail 28a of the vehicle frame 14. In this way, assembly of the battery structure 12 to the vehicle frame 14 is facilitated. Each discrete right energy absorbing structure 19a is laterally aligned with a respective left energy absorbing structure 19b and a corresponding internal cross member 42 (FIG. 5). In this way, the set of right and left energy absorbing structures 19a, 19b and the internal cross member 42 cooperate to provide enhanced load paths for distributing externally-applied loads, for example during a structural deformation event

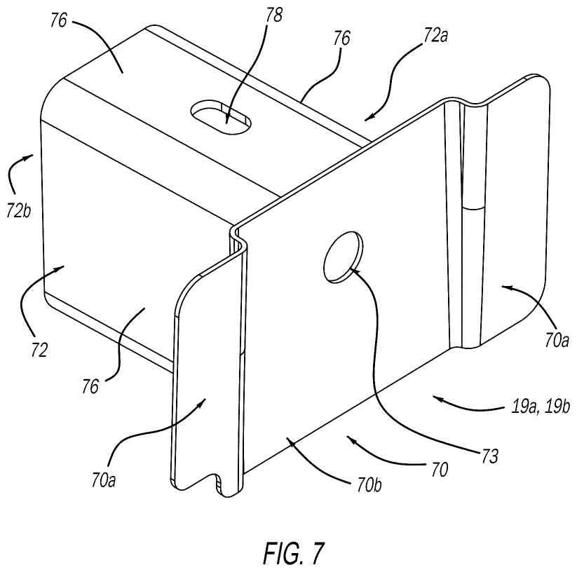

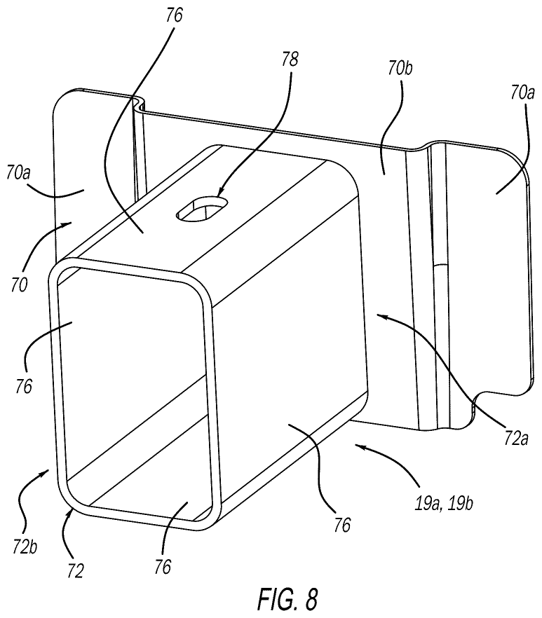

With reference to FIGS. 7 and 8, each discrete right energy absorbing structure 19a includes a base 70 and a body 72. In the example illustrated, the base 70 is fixed to the lid 38 and includes end portions 70a and a connecting portion 70b. The end portions 70a may be welded to the lid 38, thereby fixing the discrete right energy absorbing structure 19a to the lid 38. The connecting portion 70b connects the end portions 70a and is spaced apart from the lid 38. The connecting portion 70b also includes an aperture 73 (FIG. 7). A mechanical fastener (not shown; e.g., bolt or screw) may extend through the lid 38 and the aperture 73, thereby further connecting the discrete right energy absorbing structure 19a to the lid 38.

The body 72 extends from the base 70 towards the rail 28a and includes a proximal end 72a and a distal end 72b. The distal end 72b of the body 72 is spaced apart from and faces an inboard side of the rail 28a. In the example illustrated, the body 72 is a tubular shape having a rectangular profile and has a longitudinal axis that extends perpendicular to the longitudinal axis of the vehicle 10 (i.e., the rails 28a, 28b of the vehicle frame 14). In some forms, the body 72 may have a circular profile, square profile, or any other suitable profile that permits energy absorption in response to externally-applied loads associated with a structural deformation event. The body 72 has a plurality of sides 76 that cooperate to form the tubular shape. In the example illustrated, the upper side 76 includes a mounting feature 78 that is configured to attach one or more components 29 (e.g., wires, coolant lines, etc.) to the discrete right energy absorbing structure 19a. In the example illustrated, the mounting feature 78 is an aperture. In some forms, the mounting feature 78 may be a clip or any other structure that is allowed to attach the components 29 to the discrete right energy absorbing structure 19a. It is understood that another side 76 (e.g., a bottom side 76) may having a mounting feature, in addition to, or instead of, the upper side 76. In one form, the body 70 may extend laterally outward a further distance than the lid 38 or the body 40 of the battery housing 28. In other forms, the body 70 may extend laterally outward an equal distance or a smaller distance than the lid 38 or the body 40.

With reference to FIGS. 5 and 6, the set of discrete left energy absorbing structures 19b are coupled (e.g., welded) to a left side 60b of the battery housing 30 and are spaced apart along a length of the left side 60b of the battery housing 30. In the example illustrated, the set of discrete left energy absorbing structures 19b are located external to the battery housing 30 and are coupled to the lid 38 of the battery housing 30. In some forms, the set of discrete left energy absorbing structures 19b may be coupled to the body 40 of the battery housing 30. In the example illustrated, the set of discrete left energy absorbing structures 19b are spaced apart from the rail 28b of the vehicle frame 14. In this way, assembly of the battery structure 12 to the vehicle frame 14 is facilitated. Each discrete left energy absorbing structure 19b is laterally aligned with a respective right energy absorbing structure 19a and a corresponding internal cross member 42. In this way, the set of right and left energy absorbing structures 19a, 19b and the internal cross member 42 cooperate to provide enhanced load paths for distributing externally-applied loads associated with a structural deformation event. The structure and function of each discrete left energy absorbing structure 19b may be similar or identical to the discrete right energy absorbing structure 19a, and therefore, will not be described again in detail.

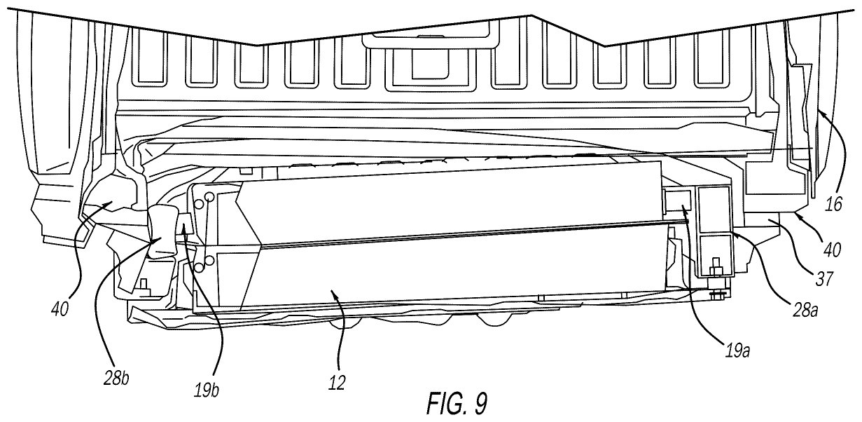

A structural assembly of the present disclosure comprises the vehicle frame 14, the vehicle body 16, the battery structure 12, and the right and left discrete energy absorbing structures 19a, 19b. The right and left discrete energy absorbing structures 19a, 19b being arranged as described above provides enhanced load paths for distributing loads during a structural deformation event. For example, as shown in FIG. 9, the structural assembly distributes a load from a respective rocker 40 through a respective rail 28a, 28b and laterally aligned energy absorbing structures 19a, 19b during the structural deformation event. In this way, the load is transferred through the battery structure 12 and away from the battery arrays 21 disposed within the battery structure 12.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C. ”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A structural assembly for a vehicle, the structural assembly comprising:
a vehicle frame having opposed longitudinal rails;
a battery structure configured to house battery components and disposed between the opposed longitudinal rails; and
at least one discrete energy absorbing structure extending from an outer side of the battery structure toward a respective longitudinal rail of the opposed longitudinal rails, the at least one discrete energy absorbing structure spaced apart from the respective longitudinal rail.

2. The structural assembly of claim 1, wherein the battery structure includes a battery tray and a lid coupled to the battery tray, and wherein the at least one discrete energy absorbing structure extends from the outer side of the lid of the battery structure.

3. The structural assembly of claim 2, wherein the battery structure includes a cross member disposed within the battery tray and spanning substantially an entire width of the battery tray, and wherein the at least one discrete energy absorbing structure is laterally aligned with the cross member.

4. The structural assembly of claim 1, wherein the battery structure includes a cross member disposed within the battery structure and spanning substantially an entire width of the battery structure, and wherein the at least one discrete energy absorbing structure is laterally aligned with the cross member.

5. The structural assembly of claim 1, wherein the at least one discrete energy absorbing structure includes a mounting feature that is configured to support vehicle components extending along the battery structure.

6. The structural assembly of claim 1, wherein the at least one discrete energy absorbing structure comprises a plurality of discrete energy absorbing structures extending from the outer side of the battery structure toward the respective longitudinal rail.

7. The structural assembly of claim 6, wherein each of the plurality of discrete energy absorbing structures includes a mounting feature that is configured to support vehicle components extending along the battery structure.

8. The structural assembly of claim 6, wherein the plurality of discrete energy absorbing structures are spaced apart from each other and aligned with each other along a longitudinal direction of the vehicle.

9. The structural assembly of claim 1, wherein the at least one discrete energy absorbing structure extends from an upper portion of the battery structure and faces an inboard side of the respective longitudinal rail.

10. The structural assembly of claim 1, further comprising a vehicle body separate from and mounted on the vehicle frame, the vehicle body including opposed rockers extending in a longitudinal direction of the vehicle, one longitudinal rail of the opposed longitudinal rail located between a respective rocker and the at least one discrete energy absorbing structure.

11. The structural assembly of claim 10, further comprising:
a plurality of mounts secured to a respective opposed longitudinal rail; and
a plurality of jounce bumpers, each jounce bumper disposed on a respective mount and between the respective mount and the vehicle body.

12. A structural assembly for a vehicle, the structural assembly comprising:
a vehicle frame having left and right longitudinal rails;
a battery structure configured to house battery components and disposed between the left and right longitudinal rails;
a set of discrete left energy absorbing structures extending from a left side of the battery structure towards the left longitudinal rail, the set of discrete left energy absorbing structures spaced apart from the left longitudinal rail; and
a set of discrete right energy absorbing structures extending from a right side of the battery structure towards the right longitudinal rail, the set of discrete right energy absorbing structures spaced apart from the right longitudinal rail.

13. The structural assembly of claim 12, wherein each left discrete energy absorbing structure is laterally aligned with a respective right discrete energy absorbing structure.

14. The structural assembly of claim 12, wherein the battery structure includes a cross member disposed within the battery structure and spanning substantially an entire width of the battery structure, and wherein one discrete left energy structure of the set of left energy structures and one discrete right energy structure of the set of right energy structures are laterally aligned with the cross member.

15. The structural assembly of claim 12, wherein the battery structure includes a battery tray and a lid coupled to the battery tray, and wherein the set of discrete left energy absorbing structures and the set of discrete right energy absorbing structure extend from an outer side of the lid of the battery structure.

16. The structural assembly of claim 12, wherein:
each of the set of discrete left energy absorbing structures includes a first mounting feature that is configured to support first vehicle components extending along the battery structure; and
each of the set of discrete right energy absorbing structures includes a second mounting feature that is configured to support second vehicle components extending along the battery structure.

17. The structural assembly of claim 12, further comprising a vehicle body separate from and mounted on the vehicle frame, the vehicle body including left and right rockers extending in a longitudinal direction of the vehicle, the left longitudinal rail located between the left rocker and the set of discrete left energy absorbing structures and the right longitudinal rail located between the right rocker and the set of discrete right energy absorbing structures.

18. The structural assembly of claim 17, further comprising:
a plurality of mounts secured to the right and left longitudinal rails; and
a plurality of jounce bumpers, each jounce bumper disposed on a respective mount and between the respective mount and the vehicle body.

19. The structural assembly of claim 12, wherein:
the set of discrete left energy absorbing structures extends from an upper portion of the battery structure and faces an inboard side of the left longitudinal rail; and
the set of discrete right energy absorbing structures extends from the upper portion of the battery structure and faces an inboard side of the right longitudinal rail.

20. A structural assembly for a vehicle, the structural assembly comprising:
a vehicle frame having left and right longitudinal rails;
a vehicle body separate from and mounted on the vehicle frame, the vehicle body including left and right rockers extending in a longitudinal direction of the vehicle;
a battery structure configured to house battery components and disposed between the left and right longitudinal rails, the battery structure includes a battery tray, a lid secured to the battery tray, and a plurality of cross members disposed within the battery structure and spaced apart along a longitudinal direction of the battery tray;
a set of discrete left energy absorbing structures extending from a left side of the lid towards the left longitudinal rail, the set of discrete left energy absorbing structures spaced apart from the left longitudinal rail; and
a set of discrete right energy absorbing structures extending from a right side of the lid towards the right longitudinal rail, the set of discrete right energy absorbing structures spaced apart from the right longitudinal rail,
wherein a respective discrete left energy structure of the set of left energy structures and a respective discrete right energy structure of the set of right energy structures are laterally aligned with a respective cross member of the plurality of cross members.
